(19) United States
(12) Patent Application Publication
(10) Pub. No.: US 2009/0273271 A1
(43) Pub. Date: Nov. 5, 2009

(54) HIGH PRESSURE METAL HALIDE LAMP

(75) Inventors: Rene Jan Hendriks, Eindhoven (NL); Henriette Jacoba Talen-Van Der Mheen, Eindhoven (NL); Volker Dirk Hildenbrand, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,312

(22) PCT Filed: Jan. 19, 2005
(86) PCT No.: PCT/IB05/50226

§ 371 Date: Jul. 20, 2006

(30) Foreign Application Priority Data
Jan. 23, 2004 (EP) 04100233.8

(51) Int. Cl. H01J 61/44

(52) U.S. Cl. 313/486

(57) ABSTRACT

The invention relates to a high-pressure metal halide lamp, comprising an arc tube (1) comprising a metal halide containing discharge medium for supporting an electrical discharge, an outer envelope (15) surrounding said arc tube (1), and a phosphor coating (14) on the inner surface of said outer envelope (15), said phosphor coating comprising a blue emitting phosphor. Preferably, the blue emitting phoshor is selected from the group consisting of (Ba,Ca)_{1.29}Al₁₂0_{19.29}:Eu, Sr₅(P0₄)₃Cl:Eu, BaMgAl₁₀0₁₇:Eu, Si2Al6011:Eu, BaAl₈0₁₃:Eu, Sr₄Al₁₄0₂₅:EU, and BaMgAl₁₀O₁₇:Eu,Mn.

The present invention relates to a high pressure metal halide lamp, comprising an arc tube comprising a metal halide containing discharge medium for supporting an electrical discharge, and an outer envelope surrounding said arc tube, said outer envelope having a phosphor coating on its inner surface.

High pressure metal halide (HPI) lamps generally produce a bright white light and are commonly used for outdoor and indoor lighting, such as in illumination of stadiums, big magazines and factory halls. The color qualities of the lamps are generally characterized by two different aspects, i.e. color temperature, and color rendering [Ra₈], which is the ability of a lamp to give good color representation of the object it is illuminating.

It is generally known to apply phosphor coatings, comprising one or more phosphor components, to the inner surface of the outer envelope of high pressure mercury vapor (HPMV) and metal halide lamps in order to provide a color shift and to improve the color rendering index Ra₈.

A high pressure 400 W metal halide lamp with incandescent lamp characteristics, having a phosphor coating comprising a mixture of strontium chloroapatite phosphor activated by divalent europium, and yttrium vanadate phosphate activated by trivalent europium is for example disclosed in GB 2 054 261. However, the overall gain in Ra₈ and luminous efficacy of this lamp is limited. In addition, the color point shifts to red and the correlated color temperature decreases.

The color temperature of a metal halide lamp is determined by the composition of discharge medium. It is thus known to influence color temperature by changing said composition of the discharge medium, i.e. changing the relative amounts of the different salts in the discharge medium. However, when for example the amount of the blue emitting indium is increased to generate light with a higher correlated color temperature, such as 6500 K for daylight, the luminous efficacy generally decreases with approximately 10-15%.

Although it is generally known that high pressure metal halide lamps offer higher efficiency (i.e. luminous efficacy) than HPMV lamps and better light quality than either mercury or sodium lamps, metal halide lamps suffer from several limitations such as the emission of significant amounts of UV-A radiation, which results in a moderate PET value.

Accordingly, there is a continued need for improvements of the lighting characteristics of high pressure metal halide lamps.

The object of the present invention is to provide a high pressure metal halide lamp with daylight characteristics, while simultaneously providing high luminous efficacy and color rendering index Ra₈.

This has been achieved by the invention by applying a phosphor coating to the inner surface of the outer envelope, comprising a blue emitting phosphor. According to the present invention it has surprisingly been found that high pressure metal halide lamps having an improved efficacy can be provided for higher color temperature, i.e. the color temperature can be shifted from 4000-5000 K to 6000-7000 K without any significant light flux loss and a similar or even improved color rendering index Ra₈. Additionally, the PET value increases from approximately 2 of a standard HPI burner or 14 of a YVO₄:Eu coated burner to greater than 50 for a lamp according to the invention.

The high pressure metal halide lamp according to the invention generally comprises an outer sealed envelope and an arc tube disposed within the outer envelope, the arc tube including a pair of spaced electrodes and a discharge medium comprising one or more metal halides, in particular a sodium halide, a thallium halide, scandium halide, and indium halide, and mercury as buffer gas. The inner surface of the outer envelope is coated with a coating comprising a blue emitting phosphor. Preferably, the blue emitting phoshor is selected from the group consisting of (Ba,Ca)_{1.29}Al₁₂O_{19.29}:Eu, Sr₅(PO₄)₃Cl:Eu, BaMgAl₁₀O₁₇:Eu, Si₂Al₆O₁₁:Eu, BaAl₈O₁₃:Eu, Sr₄Al₁₄O₂₅:Eu, and BaMgAl₁₀O₁₇:Eu,Mn.

According to a preferred embodiment of the invention the discharge medium comprises one or more metal halides, wherein the metal is chosen from the group consisting of sodium, scandium, thallium, and indium. Metal halide lamps do not have a continuous color spectrum (i.e. do not emit equal intensities over the color spectrum), but a quasi-continuous spectrum consisting of a large number of lines. The spectrum of high pressure metal halide comprising for example said metal halides sodium, thallium and indium iodide in the discharge medium intrisically comprises both red (Na), green (Tl) and blue (In) components.

According to another preferred embodiment the discharge medium comprises one or more metal halides, wherein the metal is chosen from sodium and scandium iodide, thus simplifying the processing of the discharge tubes. Despite the fact that the emission spectra are different, the present invention has also been demonstrated to work with a simple two-component ScI₃ and NaI filling (Example 2)

According to the present invention it has thus surprisingly been demonstrated that by using a coating comprising a blue emitting phosphor, a lamp is provided, which exhibits an improved efficacy at a higher color temperature, and a similar or even improved color rendering index Rag and an increased PET value, when compared to lamps without a coating. As a result of the excellent efficacy and good color rendering index, as well as the increased color temperature the lamps of the present invention are suitable for commercial lighting applications requiring a color rendering index of 65 and higher.

The present invention is further illustrated by the following Examples and Figure.

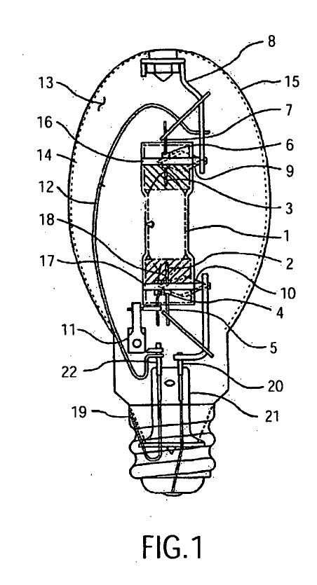

FIG. 1 is a schematic illustration of an embodiment of a metal halide lamp of the invention.

As shown in FIG. 1 the lamp according to the invention preferably comprises an arc tube 1 which is filled with a metal halide containing discharge medium, comprising mercury, and halides of one or more of the metals sodium, scandium, thallium and indium. Generally, the iodides of these metals are preferred, although bromides or chlorides may also be used. In accordance with the invention a phosphor coating 14, comprising of a blue emitting phosphor, is present on the inner surface of the outer envelope 15. Electrodes 2 and 3 are arranged in the arc tube 1. Electrode 2 is connected to a current lead-through 4,5. Electrode 3 is connected to current lead-through 6,7. An auxiliary starting probe 18 and a switch 11 play a role during lamp staring. Two getters 9 and 10 function to absorb gas impurities within the outer envelope 15. The arc tube 1 is mounted on a frame comprising metal straps 16 and 17. Current conductor 8 is connected to current lead-through 6 and 7. The wire 12, current conductors 20 and 22, stem 21 and arc tube 1 are accommodated in the ovoid outer envelope 15. The current conductors 20 and 22 are connected to the lamp cap 19.

### EXAMPLE 1

A 400 W metal halide lamp was made according to the present invention. The lamp included an arc tube having dimensions of 24 mm and 42 mm spacing between the electrodes. The arc tube contained a discharge medium comprising neon, argon, krypton and mercury and a salt filling comprising indium, sodium and thallium. The inner surface of the outer envelope was coated with BaMg₁₀O₁₇:Eu. The characteristics of the lamp according to the invention were compared with a conventional high pressure metal halide lamp without a coating. The results are summarized in table 1.

TABLE 1

| | no phosphor | BaMg₁₀O₁₇:Eu |
|---|---|---|
| x = | 0.327 | 0.309 |
| y = | 0.354 | 0.336 |
| Luminous efficacy (lm/W) | 79 | 83 |
| Tc (K) | 5700 | 6600 |

The luminous efficacy of the burner with the blue emitting phosphor is slightly better than that of the uncoated lamp despite the higher color temperature. When the same color temperature was made by increasing the amount of indium-radiation in the spectrum the luminous efficacy would have decreased by approximately 10%. According to the present invention a metal halide lamp is provided with a higher color temperature, without changing the composition of the discharge medium, while the luminous efficacy and color rendering index are maintained or even improved.

### EXAMPLE 2

A 400 W metal halide lamp as described in Example 1, the discharge medium in addition to neon, argon, krypton and mercury, comprising only the salts sodium and scandium iodide with a BaMg₁₀O₁₇:Eu coating at the inner surface of the outer envelope. The characteristics of this lamp were compared with a similar lamp without the coating. The results are summarized in table 2.

| | Luminous | | | | |
|---|---|---|---|---|---|
| | efficacy | | | T_{c} | |
| | [lm/W] | x | Y | [K] | Ra₈ |
| NaSc | 93 | 0.364 | 0.386 | 4500 | 52 |
| NaSc + BAM | 101 | 0.314 | 0.336 | 6400 | 67 |

1. High-pressure metal halide lamp, comprising an arc tube comprising a metal halide containing discharge medium for supporting an electrical discharge, an outer envelope surrounding said arc tube, and a phosphor coating on the inner surface of said outer envelope, said phosphor coating comprising a blue emitting phosphor.

2. Lamp as claimed in claim 1, wherein the blue emitting phoshor is selected from the group consisting of (Ba,Ca)_{1.29}Al₁₂O_{19.29}:Eu, Sr₅(PO₄)₃Cl:Eu, BaMgAl₁₀O₁₇:Eu, Si₂Al₆O₁₁:Eu, BaAl₈O₁₃:Eu, Sr₄Al₁₄O₂₅:Eu, and BaMgAl₁₀O_{17:}Eu,Mn.

3. Lamp as claimed in claim 1, wherein the discharge medium comprises one or more metal halides, wherein the metal is chosen from the group consisting of sodium, scandium, thallium, and indium.

4. Lamp as claimed in claim 3, wherein the discharge medium comprises one or more metal halides, wherein the metal is chosen from from sodium and scandium.
